(19) United States
(12) Patent Application Publication
(10) Pub. No.: US 2016/0272176 A1
(43) Pub. Date: Sep. 22, 2016

(54) VEHICLE CONTROL APPARATUS AND VEHICLE CONTROL SYSTEM

(71) Applicant: HITACHI AUTOMOTIVE SYSTEMS, LTD., Hitachinaka-shi, Ibaraki (JP)

(72) Inventor: Hiroshi FURUYAMA, Obihiro-shi, Hokkaido (JP)

(73) Assignee: HITACHI AUTOMOTIVE SYSTEMS, LTD., Hitachinaka-shi, Ibaraki (JP)

(21) Appl. No.: 15/033,985

(22) PCT Filed: Nov. 11, 2014
(86) PCT No.: PCT/JP2014/079827

§ 371 Date: May 3, 2016

(30) Foreign Application Priority Data
Nov. 12, 2013 (JP) 2013-234033

(51) Int. Cl. B60T 8/1761

(52) U.S. Cl. CPC B60T 8/1761

(57) ABSTRACT

An object of the present invention is to provide a vehicle control system capable of utilizing another braking apparatus than a hydraulic brake even when an ABS is activated. A vehicle control system, which is configured to be used together with a vehicle, includes a regenerative braking apparatus capable of generating a regenerative braking torque at a wheel, another braking apparatus than the regenerative braking apparatus and capable of generating a braking torque at the wheel, and a braking torque calculation unit configured to calculate a required braking torque for each of wheels of the vehicle when the wheel slips. The vehicle control system realizes the calculated braking torque by the regenerative braking apparatus and the other braking apparatus.

### TECHNICAL FIELD

The present invention relates to a vehicle control apparatus and a vehicle control system.

### BACKGROUND ART

As this kind of technique, there is a technique disclosed in the following patent literature, PTL 1. PTL 1 discloses a technique that stops a request for regenerative braking when an ABS is activated, and performs ABS control with use of a hydraulic brake.

### CITATION LIST

### Patent Literature

PTL 1: Japanese Patent Application Public Disclosure No. 2012-131306

### SUMMARY OF INVENTION

### Technical Problem

The invention discussed in PTL 1 performs the ABS control with use of only the hydraulic brake when the ABS is activated, and therefore cannot utilize another braking apparatus than the hydraulic brake when the ABS is activated. Especially, when a regenerative braking apparatus and the ABS are in an activated state at the same time, this invention cannot sufficiently collect regenerated energy.

The present invention has been made in consideration of the above-described drawback, and an object thereof is to provide a vehicle control system capable of utilizing another braking apparatus than the hydraulic brake even when the ABS is activated.

### Solution to Problem

To achieve the above-described object, according to a first aspect of the present invention, a vehicle control apparatus, which is configured to be used together with a vehicle, includes a braking torque calculation unit configured to calculate a required braking torque for each of wheels of the vehicle when a wheel slips, a hydraulic control apparatus including a hydraulic anti-lock control unit configured to adjust a wheel cylinder hydraulic pressure by applying the calculated braking torque, and a braking apparatus provided separately from the hydraulic control apparatus and configured to generate a second braking torque. The hydraulic control apparatus and the braking apparatus are connected to each other so as to be able to communicate a result output by the braking torque calculation unit. The hydraulic control apparatus transmits the calculated braking torque to the braking apparatus. The braking apparatus includes a braking apparatus anti-lock control unit configured to generate the second braking torque based on the acquired calculated braking torque.

According to a second aspect of the present invention, a vehicle control apparatus includes a braking torque calculation unit configured to calculate a braking torque required to be applied to each of wheels of a vehicle when the wheel slips, a hydraulic anti-lock control unit configured to adjust a wheel cylinder hydraulic pressure by applying the calculated braking torque, and a braking torque transmission unit configured to transmit the braking torque calculated by the braking torque calculation unit to a regenerative braking apparatus configured to generate a regenerative braking torque at the wheel.

According to a third aspect of the present invention, a vehicle control apparatus includes a braking torque calculation unit configured to calculate a braking torque required to be applied to each of wheels of a vehicle when the wheel slips, a hydraulic anti-lock control unit configured to adjust a wheel cylinder hydraulic pressure by applying the calculated braking torque, and a braking torque transmission unit configured to transmit the braking torque calculated by the braking torque calculation unit to a braking apparatus configured to generate a second braking torque at the wheel.

According to a fourth aspect of the present invention, a vehicle control system includes a regenerative braking apparatus capable of generating a regenerative braking torque at a wheel, another braking apparatus than the regenerative braking apparatus and capable of generating a braking torque at the wheel, and a braking torque calculation unit configured to calculate a required braking torque for each of wheels of the vehicle when the wheel slips. The vehicle control system realizes the calculated braking torque by the regenerative braking apparatus and the other braking apparatus.

### BRIEF DESCRIPTION OF DRAWINGS

FIG. 1 illustrates an overall system of a brake apparatus according to a first embodiment.

FIG. 2 is a control block diagram of the brake apparatus according to the first embodiment.

FIG. 3 illustrates a hydraulic circuit in a hydraulic control unit according to the first embodiment.

FIG. 4 is a block diagram illustrating each controller according to the first embodiment.

FIG. 5 is a timing diagram of the first embodiment.

FIG. 6 is a block diagram illustrating each controller according to a second embodiment.

FIG. 7 is a block diagram illustrating each controller according to a third embodiment.

FIG. 8 is a timing diagram of the third embodiment.

FIG. 9 is a block diagram illustrating each controller according to a fourth embodiment.

FIG. 10 is a block diagram illustrating each controller according to a fifth embodiment.

### DESCRIPTION OF EMBODIMENTS

### First Embodiment

### Overall Configuration of Brake Apparatus

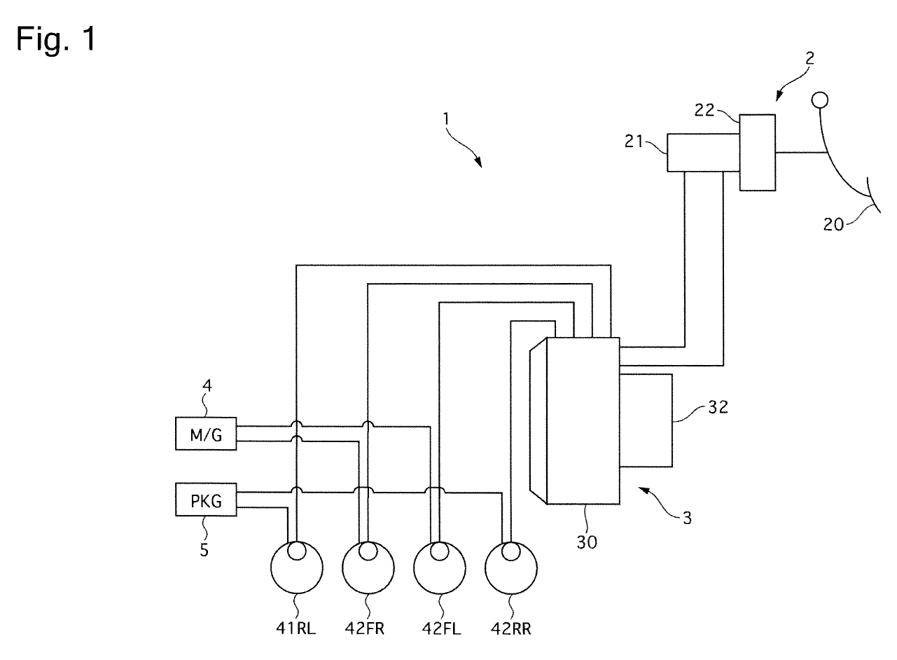

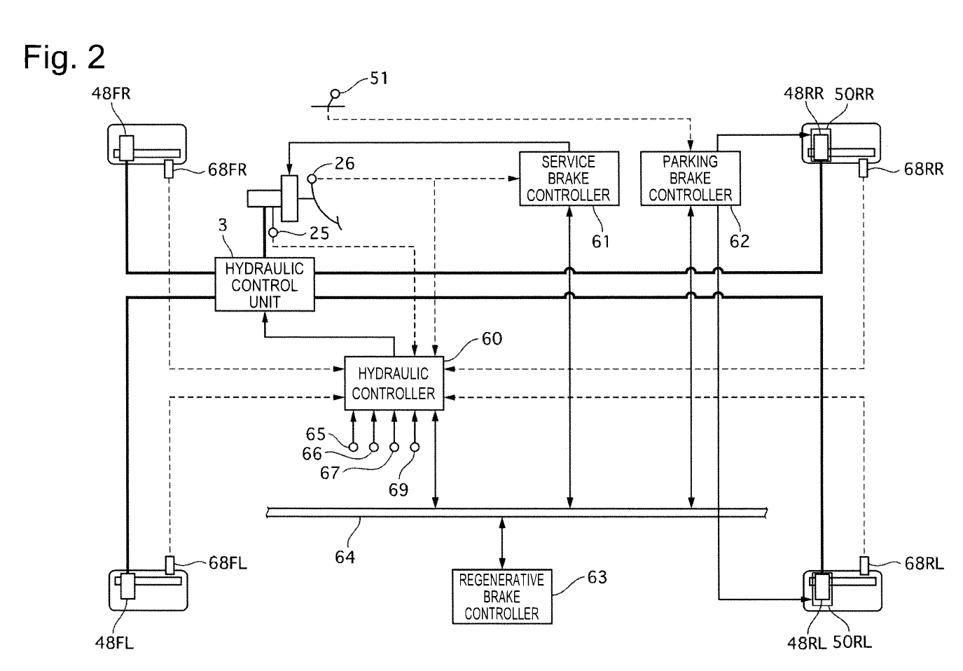

A brake apparatus 1 according to a first embodiment will be described. FIG. 1 illustrates an overall system of the brake apparatus 1. The brake apparatus 1 according to the first embodiment includes a hydraulic control unit 3 capable of generating a brake hydraulic pressure separately from a service brake 2. Further, a vehicle on which the brake apparatus 1 according to the first embodiment is mounted is a front-wheel drive hybrid automobile or electric automobile, and includes a regenerative brake 4 using a motor generator. The regenerative brake 4 can apply a braking force to a front wheel. Further, this vehicle includes an electric parking brake 5 that detects an operation of a parking brake switch 51 performed by a driver to thereby drive an electric caliper 50 (refer to FIG. 2) to then generate a braking force mainly while the vehicle is parked.

The service brake 2 is configured to be able to increase a brake hydraulic pressure in a master cylinder 21 by the driver's pressing a brake pedal 20, and also be able to boost the master cylinder hydraulic pressure by the driver's pressing the brake pedal 20 with use of an electric booster 22. Further, the electric booster 22 can automatically generate the master cylinder hydraulic pressure to supply brake fluid into wheel cylinder(s) 42 even when the brake pedal 20 is not pressed.

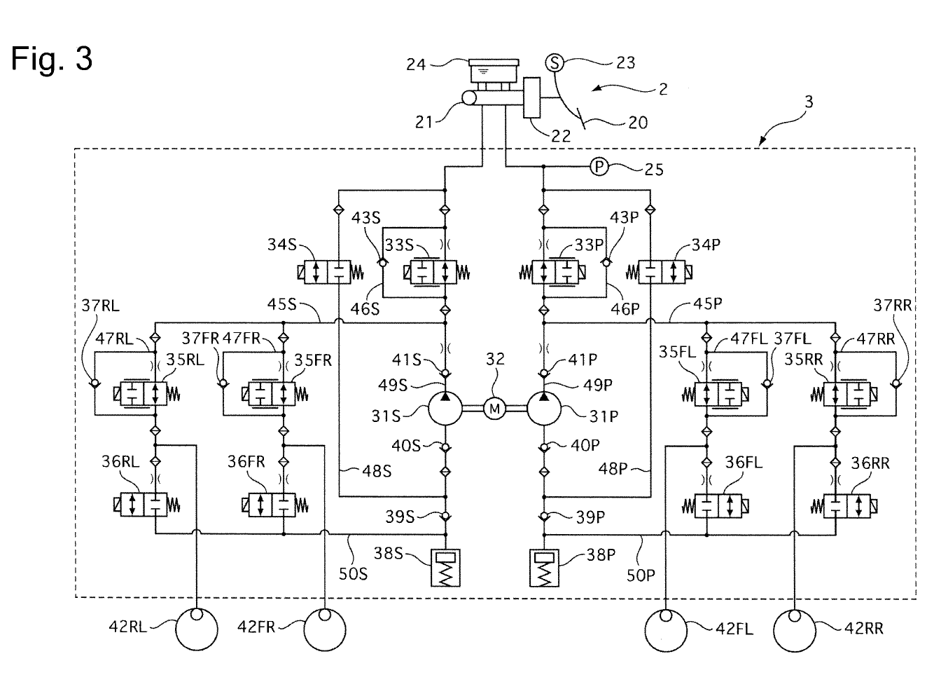

The hydraulic control unit 3 includes hydraulic passages formed inside a housing 30, and control valves provided at intermediate positions along these hydraulic passages. Further, a pump 31 (refer to FIG. 3), which is driven by a motor 32, is provided in the housing 30, so that the hydraulic control unit 3 can boost the brake hydraulic pressure generated in the master cylinder 21 of the service brake 2 with use of the pump 31 to supply the boosted brake hydraulic pressure into the wheel cylinder 42. Further, the hydraulic control unit 3 can supply the brake fluid into the wheel cylinder 42 with use of the pump 31 even when the master cylinder hydraulic pressure is not generated by the service brake 2. Further, the hydraulic control unit 3 can also return the brake fluid stored in a reservoir 38 (refer to FIG. 3) to the master cylinder 21 with use of the pump 31 when ABS control is in operation.

[Control Block Diagram of Brake Apparatus]

FIG. 2 is a control block diagram of the brake apparatus 1. The brake apparatus 1 includes a hydraulic controller 60, which controls the pump 31 and each of the control valves in the hydraulic control unit 3, a service brake controller 61, which controls the electric booster 22, a regenerative brake controller 63, which controls the regenerative brake 4, and a parking brake controller 62, which controls the electric parking brake 5.

Data input to the hydraulic controller 60 includes wheel speed information output from wheel speed sensors 68FL, 68FR, 68RL, and 68RR respectively mounted on wheels, yaw rate information output from a yaw rate sensor 65, lateral acceleration information output from a lateral acceleration sensor 66, longitudinal acceleration information output from a longitudinal acceleration sensor 67, information indicating a vibration of the wheel or a vehicle body that is output from a vibration sensor 69, master cylinder hydraulic information output from a master cylinder hydraulic sensor 25, and information indicating a stroke amount of the brake pedal 20 that is output from a stroke sensor 26. The information indicating the stroke amount of the brake pedal 20 is input from the stroke sensor 26 to the service brake controller 61. Each of the controllers is connected to a CAN 64 so as to be communicable with one another, whereby the information input by each of the controllers is also supplied to the other controllers. Further, a calculated value, an instruction value, and the like in each of the controllers are also shared with the other controllers via the CAN 64.

[Configuration of Hydraulic Control Unit]

FIG. 3 illustrates a hydraulic circuit in the hydraulic control unit 3. The hydraulic circuit is divided into two systems, a primary system and a secondary system, and forms a so-called X type dual circuit with the primary system connected to a wheel cylinder 42FL of a front left wheel and a wheel cylinder 42RR of a rear right wheel, and the secondary system connected to a wheel cylinder 42FR of a front right wheel and a wheel cylinder 42RR of a rear right wheel. Hereinafter, “P” and “S” will be added to reference numerals of components provided in the primary system and reference numerals of components provided in the secondary system, respectively, but will be omitted when the component is not specifically defined as to whether it belongs to the primary system or the secondary system. Further, “FL”, “FR”, “RL”, and “RR” will be added to reference numerals of components provided in correspondence to the individual wheels, respectively, but will also be omitted when the component is not specifically defined as to which wheel it is associated with.

A pump 31P and a pump 31S are provided in the primary system and the secondary system, respectively. The pump 31 is driven by the single motor 32.

The master cylinder 21, and the wheel cylinder 42FL of the front left wheel and the wheel cylinder 42RR of the rear right wheel are connected to each other via a hydraulic passage 45P. The master cylinder 21, and the wheel cylinder 42FR of the front right wheel and the wheel cylinder 42RL of the rear left wheel are connected to each other via a hydraulic passage 455. A gate-out valve 33P or 33S, which is a normally-closed proportional valve, is provided in the hydraulic passage 45. A bypass hydraulic passage 46P or 46S, which bypasses the gate-out valve 33, is formed in the hydraulic passage 45. A one-way valve (unidirectional valve or check valve) 43P or 43S is provided in the bypass hydraulic passage 46. The one-way valve 43 permits the brake fluid to flow from the master cylinder 21 toward the wheel cylinder 42 side but prohibits the brake fluid from flowing in an opposite direction.

Pressure increase valves 35FL and 35RR, or 35RL and 35FR, which are normally-closed proportional valves, are provided between the gate-out valve 33 and the wheel cylinders 42FL and 42RR, or 42RL and 42FR in the hydraulic passage 45, respectively. Bypass hydraulic passages 47FL and 47RR, or 47RL and 47FR, which bypass the pressure increase valves 35, are formed in the hydraulic passage 45. One-way valves 37FL and 37RR, or 37RL and 37FR are provided in the bypass passages 47. The one-way valve 37 permits the brake fluid to flow from the wheel cylinder 42 toward the master cylinder 21 side but prohibits the brake fluid from flowing in an opposite direction.

The master cylinder 21 and an intake side of the pump 31 are connected to each other via the hydraulic passage 48P or 48S. A gate-in valve 34P or 34S, which is a normally-closed ON/OFF valve, is provide in the hydraulic passage 48. Further, an intake valve 40P or 40S is provided between the pump 31 and the gate-in valve 34 in the hydraulic passage 48. The intake valve 40 permits the brake fluid to flow toward the intake side where the brake fluid is fed into the pump 31 but prohibits the brake fluid from flowing in an opposite direction.

A portion between the gate-out valve 33 and the pressure increase valve 35 in the hydraulic passage 45, and the pump 31 are connected to each other via the hydraulic passage 49P or 495. A discharge valve 41P or 41S is provided in the hydraulic passage 49. The discharge valve 41 permits a flow of the brake fluid discharged from the pump 31 but prohibits a flow in an opposite direction.

A portion between the gate-out valve 35 in the hydraulic passage 45 and each of the wheel cylinders 42, and a portion between the gate-in valve 34 and the intake valve 40 in the hydraulic passage 48 are connected to each other via a hydraulic passage 50P or 505. Pressure reduction valves 36FL and 36RR, or 36RL and 36FR, which are normally closed ON/OFF valves, are provided in the hydraulic passage 50. Further, a reservoir 38P or 38S is provided between the pressure reduction valves 36 and the intake valve 40 in the hydraulic passage 50. A one-way valve 39P or 39S is provided on the pump 31 side with respect to the reservoirs 38. The one-way valve 39 permits the brake fluid to flow from the reservoir 38 toward the pump 31 side but prohibits the brake fluid from flowing in an opposite direction.

The master cylinder hydraulic sensor 25 is provided between the master cylinder 21 and the gate-out valve 33P in the hydraulic passage 45P on the primary side. The master cylinder hydraulic sensor 25 may be provided inside the master cylinder 21 without being provided in the hydraulic control unit 3.

[Configurations of Controllers]

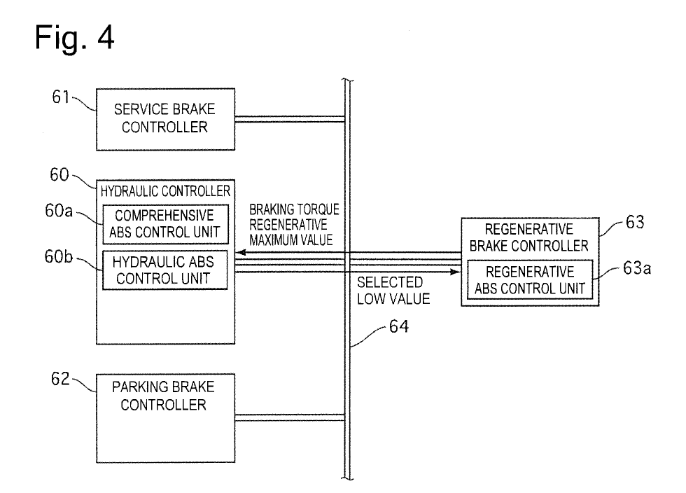

FIG. 4 is a block diagram illustrating the hydraulic controller 60, the service brake controller 61, the parking brake controller 62, and the regenerative brake controller 63. The hydraulic controller 60 includes a comprehensive ABS control unit 60a and a hydraulic ABS control unit 60b. The regenerative brake controller 63 includes a regenerative ABS control unit 63a.

The hydraulic controller 60, the service brake controller 61, and the regenerative brake controller 63 control distribution between the regenerative brake and the hydraulic brake so as to maximize an amount regenerated by the regenerative brake 4 when the vehicle is normally braked. Further, the hydraulic controller 60, the service brake controller 61, and the regenerative brake controller 63 control the master cylinder pressure and control the stroke amount on the brake pedal 2 side so as to prevent or reduce a change thereof at the time of a shift between the regenerative brake and the hydraulic brake when the regenerative brake is activated.

In the first embodiment, the braking force under the ABS control, which prevents or reduces a lock of the wheel when the wheel slips, is realized by the hydraulic control unit 3 and the regenerative brake 4. The comprehensive ABS control unit 60a calculates a braking torque required to be applied to each of the wheels so as to secure a force for braking the vehicle while preventing or reducing the lock of the wheel when the wheel slips (hereinafter referred to as a required braking torque). The comprehensive ABS control unit 60a inputs a current maximum value of a regenerative braking torque from the regenerative brake controller 63. The comprehensive ABS control unit 60a compares a smallest required braking torque of the individual wheels (hereinafter referred to as a minimum required braking torque) with the regenerative brake maximum value, and outputs a smaller value therebetween to the regenerative ABS control unit 63a as an instruction value (hereinafter referred to a selected low value).

The regenerative ABS control unit 63a controls a braking torque for the front wheel, which is a regenerative wheel, by the regenerative brake 4 based on the selected low value. The hydraulic ABS control unit 60b controls the hydraulic control unit 3 based on a braking torque by which the selected low value is short of the required braking torque for the front wheel. Further, the hydraulic ABS control unit 60b controls a braking torque for the rear wheel based on the required braking torque for the rear wheel, which is not the regenerative wheel.

[Function] Conventionally, upon a start of intervention of the ABS control due to, for example, occurrence of a slip at the wheel, the regenerative brake 4 has been stopped to stabilize a behavior of the vehicle, and the braking torque for each of the wheels has been controlled by the hydraulic control unit 3. Therefore, the intervention of the ABS control has resulted in a reduction in a power amount generated by the regeneration, leading to lower efficiency of power generation. Further, the stop of the regenerative brake 4 has required a complicated control logic, thereby necessitating provision of a high-speed processor and the like and thus causing a cost increase.

Therefore, the first embodiment is configured to generate the required braking torque for each of the wheels by the regenerative brake 4 and the hydraulic control unit 3 even when the ABS control intervenes.

Further, in the first embodiment, the regenerative brake 4 is controlled based on the selected low value, which is the smaller value between the maximum regenerative braking torque that the regenerative brake 4 can generate, and the minimum value of the required braking torques for the front wheels (the regenerative wheels). Then, the hydraulic control unit 3 is controlled based on the braking torque by which the selected low value is short of the required braking torque for the front wheel.

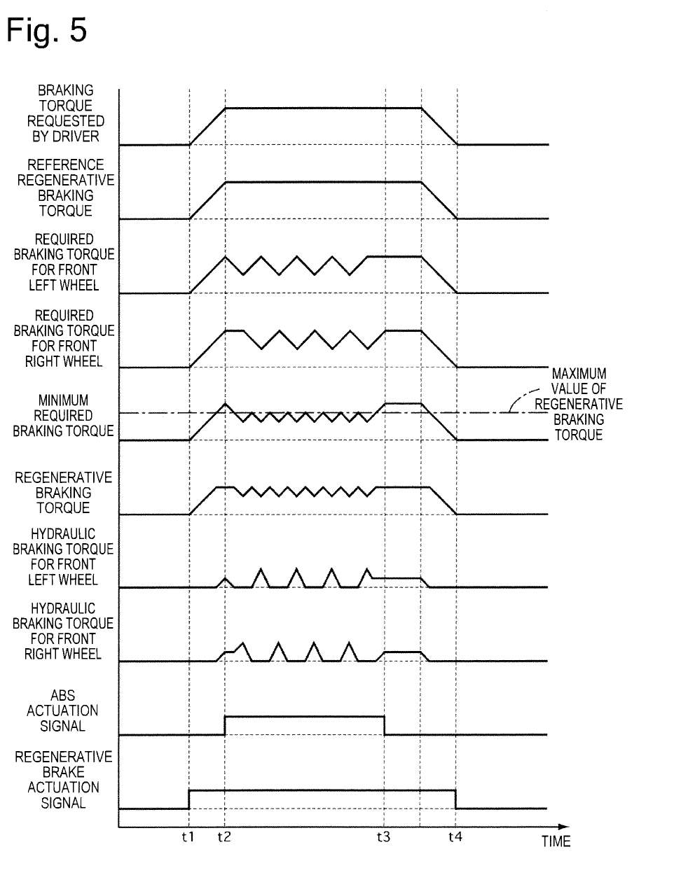

FIG. 5 is a timing diagram. A regenerative brake activation signal is kept turned on from time t1 to time t4, during which the brake pedal 20 is operated by the driver and a requested braking torque is maintained. Then, an ABS activation signal is kept turned on and the ABS control continues the intervention from time t2 to time t3, during which the wheel slips at a high slip rate. As illustrated in FIG. 5, the regenerative braking torque is kept output even after time t2 from which the ABS control intervenes. This output can enhance the power generation efficiency. Further, the regenerative braking torque is output based on the smaller value (the selected low value) between the minimum value of the required braking torques for the front wheels (the minimum required braking torque) and the maximum value of the regenerative braking torque. This output can enhance the power generation efficiency even when the ABS control is in operation. Further, the braking torque by which the regenerative braking torque is short of the required braking torque for the front wheel is output as the hydraulic braking torque for each of the wheels. This addition can secure the required braking torque for each of the wheels.

[Effect]

(1) The first embodiment includes the regenerative brake 4 (a regenerative braking apparatus) capable of generating the regenerative braking torque to be applied to the wheel, the hydraulic control unit 3 (a braking apparatus) capable of generating the braking torque to be applied to the wheel, which is another braking apparatus than the regenerative braking apparatus, and the comprehensive ABS control unit 60a (a braking torque calculation unit) configured to calculate the required braking torque for each of the wheels of the vehicle when the wheel slips (a required braking torque). the required braking torque is realized by the regenerative brake 4 and the hydraulic control unit 3.

Therefore, the power generation efficiency can be enhanced because generating the regenerative braking torque by the regenerative brake 4 even when the ABS control is in operation.

(2) The first embodiment is configured to generate the selected low braking torque, which is the smaller value between the maximum regenerative braking torque that the regenerative brake 4 can generate and the minimum value of the required braking torques (the minimum required braking torque), with use of the regenerative brake 4, and generate the torque corresponding to the difference between the unselected braking torque and the selected braking torque with use of the hydraulic control unit 3.

Therefore, power as much as possible can be generated when the ABS control is in operation, thereby enhancing the power generation efficiency. Further, the first embodiment can generate the braking torque by which the regenerative braking torque is short of the required braking torque with use of the hydraulic control unit 3, thereby securing the required braking torque for each of the wheels.

### Second Embodiment

The brake apparatus 1 according to a second embodiment will be described. The second embodiment is different from the first embodiment in terms of a part of the configurations of the controllers. Components similar to the first embodiment will be identified by the same reference numerals, and will not be described below.

[Configurations of Controllers]

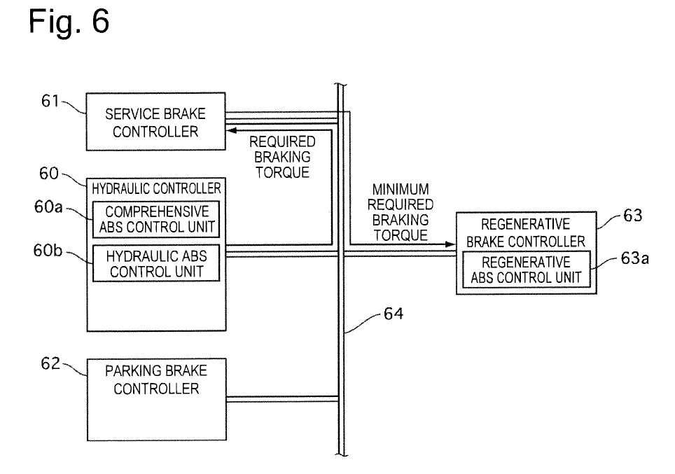

FIG. 6 is a block diagram illustrating the hydraulic controller 60, the service brake controller 61, the parking brake controller 62, and the regenerative brake controller 63. The hydraulic controller 60 includes the comprehensive ABS control unit 60a and the hydraulic ABS control unit 60b. The regenerative brake controller 63 includes the regenerative ABS control unit 63a

The hydraulic controller 60, the service brake controller 61, and the regenerative brake controller 63 control the distribution between the regenerative brake and the hydraulic brake so as to maximize the amount regenerated by the regenerative brake 4 when the vehicle is normally braked. Further, the hydraulic controller 60, the service brake controller 61, and the regenerative brake controller 63 control the master cylinder pressure and control the stroke amount on the brake pedal 2 side so as to prevent or reduce the change thereof at the time of the shift between the regenerative brake and the hydraulic brake when the regenerative brake is activated.

In the second embodiment, the braking force under the ABS control, which prevents or reduces the lock of the wheel when the wheel slips, is realized by the hydraulic control unit 13 and the regenerative brake 4. The comprehensive ABS control unit 60a calculates the braking torque required to be applied to each of the wheels so as to secure the force for braking the vehicle while preventing or reducing the lock of the wheel when the wheel slips (hereinafter referred to as the required braking torque). At this time, the comprehensive ABS control unit 60a calculates the required braking torque so as to acquire a smaller value as this torque if the vibration sensor 69 detects the vibration of the wheel or the vehicle body.

The comprehensive ABS control unit 60a transmits the required braking torque for each of the wheels to the service brake controller 61. The service brake controller 61 transmits the required braking torque having the minimum value (the minimum required braking torque) of the required braking torques for the individual wheels that are acquired from the comprehensive ABS control unit 60a (the hydraulic controller 60) to the regenerative brake controller 63.

The regenerative ABS control unit 63a controls the braking torque for the front wheel, which is the regenerative wheel, by the regenerative brake 4 based on the input minimum required braking torque. The comprehensive ABS control unit 60a controls the hydraulic control unit 3 based on the braking torque by which the minimum required torque is short of the required braking torque for the front wheel. Further, the hydraulic ABS control unit 60b controls the braking torque for the rear wheel based on the required braking torque for the rear wheel, which is not the regenerative wheel. If both the regenerative braking torque and the hydraulic braking torque are applied before the ABS control intervenes, a second slip rate, which is a slip rate of the wheel for triggering the intervention of the regenerative ABS control unit 63a in the anti-lock control (control for reducing the regeneration), is set to a smaller value than a first slip rate, which is a slip rate of the wheel for triggering the intervention of the hydraulic ABS control unit 60b in the anti-lock control (control for reducing the hydraulic pressure). In other words, the second embodiment is configured to start from reducing the regenerative braking torque when the ABS control intervenes. Further, the regenerative ABS control unit 63a is configured to apply a driving torque to the front wheel, when the front wheel, which is the regenerative wheel, slips by a large slip amount while the ABS control is in operation. Further, the regenerative ABS control unit 63a controls the regenerative braking torque in such a manner that the incremental gradient of the regenerative braking torque is less than the decremental gradient thereof while the ABS control is in operation.

In the above-described example, the minimum required braking torque is transmitted from the hydraulic controller 60 via the service brake controller 61, but may be transmitted in another manner. For example, the second embodiment may be configured in such a manner that the comprehensive ABS control unit 60a calculates the minimum required braking torque therein, and the minimum required braking torque is directly transmitted from the hydraulic controller 60 to the regenerative brake controller 63.

Alternatively, the second embodiment may be configured in such a manner that the required braking torque for each of the wheels is transmitted from the hydraulic controller 60 to the regenerative brake controller 63, and the regenerative ABS control unit 63a calculates the minimum required braking torque.

Further, the minimum required braking torque has been defined to refer to the smallest required braking torque of the required braking torques for the individual wheels. However, in the case where the vehicle is the front-wheel drive vehicle, like the second embodiment, the smaller required braking torque between the required braking torques for the front wheels, which are the regenerative wheels, may be set as the minimum required braking torque.

[Function]

The second embodiment is configured to generate the required braking force for each of the wheels by the regenerative brake 4 and the hydraulic control unit 3 even when the ABS control intervenes. By this configuration, the second embodiment can keep the regenerative brake 4 operable even after the ABS control intervenes, and thus can perform the ABS control while utilizing another braking apparatus than the hydraulic brake.

Further, in the second embodiment, the regenerative brake controller 63 is configured to apply the smallest required braking torque (the minimum required braking torque) of the required braking torques for the individual wheels that are acquired from the hydraulic controller 60 to the front wheel as the regenerative braking torque. This configuration eliminates the necessity of calculating the minimum required braking torque on the hydraulic controller 60 side, which contributes to a reduction in a load on the hydraulic controller 60.

Alternatively, in the second embodiment, the hydraulic controller 60 is configured to calculate the smallest required braking torque of the required braking torques for the individual wheels (the minimum required braking torque) to then transmit the calculated smallest required braking force to the regenerative brake controller 63, and the regenerative brake controller 63 is configured to apply the acquired minimum required braking torque to the front wheel as the regenerative braking torque. This configuration eliminates the necessity of calculating the minimum required braking torque on the regenerative brake controller 63 side, which contributes to a reduction in a load on the regenerative brake controller 63.

Further, the second embodiment is configured to use the regenerative brake 4, which generates an electric braking torque, as another braking apparatus than the hydraulic brake. By this configuration, the second embodiment can collect regenerated energy, thereby enhancing the energy efficiency.

Further, in the second embodiment, the smaller required braking torque between the required braking torques for the front wheels, which are the regenerative wheels, is set as the minimum required braking torque. This configuration allows the regenerative braking torque for the front wheel to reach or fall below the required braking torque upon the intervention of the ABS control while the regenerative braking torque is generated, thereby succeeding in stabilizing the behavior of the vehicle.

Further, the second embodiment is configured in such a manner that, when the ABS control intervenes while the hydraulic control unit 3 and the regenerative brake 4 each generate the braking torque, the regenerative braking torque generated by the regenerative brake 4 reduces earlier than the hydraulic braking torque generated by the hydraulic control unit 3 reduces. Reducing the hydraulic braking torque requires driving of the valves and the motor 32 in the hydraulic control unit 3, which may lead to a louder activation noise. On the other hand, reducing the regenerative braking torque requires a reduction in an output of the motor generator, but the reduction in the output can turn down the activation noise. Therefore, reducing the regenerative braking torque can more effectively ensure that tranquility is maintained compared to reducing the hydraulic braking torque.

Further, in the second embodiment, the regenerative ABS control unit 63a is configured to apply the driving torque to the regenerative wheel when the regenerative wheel (the front wheel) slips by a large slip amount. By this configuration, the second embodiment can prevent or reduce an excessive slip of the regenerative wheel.

Further, in the second embodiment, the service brake controller 61 is configured to transmit the smallest minimum required braking torque of the required braking torques for the individual wheels that are acquired from the hydraulic controller 60 to the regenerative brake controller 63. By this configuration, the second embodiment can acquire the minimum required braking torque with use of the service brake controller 61, which is subject to a relatively low calculation load when the ABS control is in operation, thereby preventing or reducing an addition of the calculation load on the hydraulic controller 61 and the regenerative brake controller 63.

Further, in the second embodiment, the comprehensive ABS control unit 60a is configured to reduce the required braking torque for each of the wheels when a vibration is detected by the vibration sensor 69, which detects the vibration of the wheel or the vibration of the vehicle body. By this configuration, the second embodiment can reduce the braking torque for each of the wheels, thereby eliminating or reducing the vibration of the wheel or the vibration of the vehicle body.

Further, in the second embodiment, the second slip rate for triggering the intervention of the regenerative ABS control unit 63a in the ABS control is set to a lower slip rate than the first slip rate for triggering the intervention of the hydraulic ABS control unit 60b in the ABS control. The low slip rate means that the wheel has a weak lock tendency. In other words, the regenerative ABS control unit 63a can intervene in the ABS control at an earlier timing than the timing at which the hydraulic ABS control unit 60b intervenes in the ABS control. This arrangement is set to reduce the regenerative braking torque generated by the regenerative brake 4 before reducing the hydraulic braking torque generated by the hydraulic control unit 3 when the ABS control intervenes. By this configuration, the second embodiment can ensure that the tranquility is maintained when the ABS control intervenes.

Further, the second embodiment is configured in such a manner that the required braking torque is transmitted from the hydraulic controller 60 to the regenerative brake controller 63 and that the incremental gradient of the required braking torque is less than the decremental gradient thereof. By this configuration, the second embodiment can effectively prevent or reduce the slip of the wheel due to the incremental gradient of the required braking torque being decreased, and effectively prevent or reduce the lock tendency of the wheel due to the decremental gradient of the required braking torque being increased.

[Effect]

(3) The second embodiment includes the comprehensive ABS control unit 60a (a braking torque calculation unit) configured to calculate the required braking torque for each of the wheels of the vehicle when the wheel slips (the required braking torque), the hydraulic controller 60 (a hydraulic control apparatus) including the hydraulic ABS control unit 60b (a hydraulic anti-lock control unit) configured to adjust the wheel cylinder hydraulic pressure by applying the required braking torque, and the regenerative brake controller 63 (a braking apparatus) provided separately from the hydraulic controller 60 and configured to generate the regenerative braking torque (a second braking torque). The hydraulic controller 60 and the regenerative brake 4 are connected to each other so as to be able to communicate the result output by the comprehensive ABS control unit 60a. The hydraulic controller 60 transmits the required braking torque to the regenerative brake controller 63. The regenerative brake controller 63 includes the regenerative ABS control unit 63a configured to generate the regenerative braking torque based on the acquired required braking torque.

Therefore, the ABS control can be performed by utilizing another braking apparatus than the hydraulic brake.

(4) The regenerative brake controller 63 is configured to generate the smallest required braking torque of the acquired required braking torques for the individual wheels at each of the wheels as the regenerative braking torque.

Therefore, the load on the hydraulic controller 60 can be reduced.

(5) The hydraulic controller 60 is configured to transmit the smallest braking torque of the calculated required braking torques for the individual wheels to the regenerative brake controller 63, and the regenerative brake controller 63 is configured to generate the acquired minimum required braking torque at each of the wheels as the regenerative braking torque.

Therefore, the load on the regenerative brake controller 63 can be reduced.

(6) The regenerative brake 4 is configured as the apparatus that generates the electric braking torque.

Therefore, the energy efficiency can be enhanced.

(7) The hydraulic controller 60 is configured to transmit the minimum required braking torque of the required braking torques for the regenerative wheels that are predetermined from the wheels.

Therefore, the behavior of the vehicle can be stabilized.

(8) The second embodiment is configured to reduce the regenerative braking torque generated by the regenerative brake 4 earlier than reduce the hydraulic braking torque generated by the hydraulic control unit 3 when the wheel slips while the hydraulic control unit 3 and the regenerative brake 4 each generate the braking torque.

Therefore, maintaining of the tranquility when the ABS control intervenes can be ensured.

(9) The second embodiment is configured to transmit the driving torque as the braking torque transmitted to the regenerative brake controller 63 when the regenerative wheel largely slips.

Therefore, the excessive slip of the regenerative wheel can be prevented or reduced.

(10) The second embodiment includes

the electric booster 22 and the service brake controller 61 (a braking booster) that are configured to create the master cylinder hydraulic pressure according to the operation performed by the driver on the brake pedal, and

the regenerative brake 4 and the regenerative brake controller 63 (a regenerative braking apparatus) that are configured to generate the electric braking torque. The service brake controller 61 is configured to transmit the smallest braking torque of the braking torques for the individual wheels that are acquired from the hydraulic controller 60 to the regenerative brake controller 63 as the minimum required braking torque.

Therefore, the addition of the calculation load on the hydraulic controller 60 and the regenerative brake controller 63 can be prevented or reduced.

(11) The second embodiment includes the vibration sensor 69 (a vibration detection uni) configured to detect the vibration of the wheel or the vehicle body including the wheel. The hydraulic controller 60 is configured to reduce the required braking torque if the vibration is detected by the vibration sensor 69.

Therefore, the vibration of the wheel or the vibration of the vehicle body can prevent or reduce.

(12) The second embodiment includes the first slip rate for triggering the intervention of the hydraulic ABS control unit 60b in the anti-lock control, and the second slip rate for triggering the intervention of the regenerative ABS control unit 63a in the anti-lock control. The second slip rate is set to a lower slip rate than the first slip rate.

Therefore, maintaining of the tranquility when the ABS control intervenes can be ensured.

(13) the required braking torque is transmitted to the regenerative brake controller 63 and the incremental gradient of the required braking torque is less than the decremental gradient thereof.

Therefore, the slip of the wheel can be effectively prevented or reduced and the lock tendency of the wheel also can be effectively prevented or reduced.

(14) The second embodiment includes the comprehensive ABS control unit 60a (a braking torque calculation unit) configured to calculate the required braking torque for each of the wheels of the vehicle when the wheel slips (the required braking torque), the hydraulic ABS control unit 60b (a hydraulic anti-lock control unit) configured to adjust the wheel cylinder hydraulic pressure by applying the calculated required braking torque, and the CAN 64 (a required torque transmission unit) configured to transmit the required braking torque calculated by the comprehensive ABS control unit 60a to the regenerative brake controller 63 (a regenerative braking apparatus) configured to generate the regenerative braking torque at the wheel.

Therefore, the power generation efficiency can be enhanced because generating the regenerative braking torque by the regenerative brake 4 even when the ABS control is in operation.

(15) The second embodiment includes the comprehensive ABS control unit 60a (a braking torque calculation unit) configured to calculate the required braking torque for each of the wheels of the vehicle when the wheel slips, the hydraulic ABS control unit 60b (a hydraulic anti-lock control unit) configured to adjust the wheel cylinder hydraulic pressure by applying the calculated required braking torque, and the CAN 64 (a braking torque transmission unit) configured to transmit the required braking torque calculated by the comprehensive ABS control unit 60a to the regenerative brake 4 and the regenerative brake controller 63 (a regenerative braking apparatus) configured to generate the regenerative braking torque (a second braking torque) at the wheel.

Therefore, the power generation efficiency can be enhanced because generating the regenerative braking torque by the regenerative brake 4 even when the ABS control is in operation.

### Third Embodiment

The brake apparatus 1 according to a third embodiment will be described. The third embodiment is different from the first embodiment in terms of a part of the configurations of the controllers. Components similar to the first embodiment will be identified by the same reference numerals, and will not be described below.

[Configurations of Controllers]

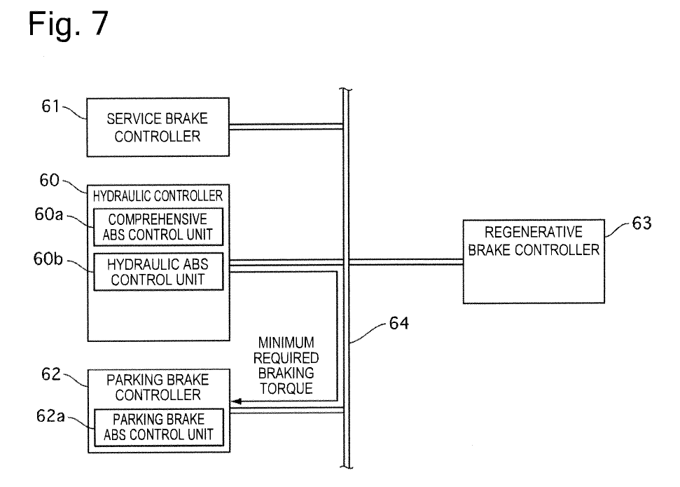

FIG. 7 is a block diagram illustrating the hydraulic controller 60, the service brake controller 61, the parking brake controller 62, and the regenerative brake controller 63. The hydraulic controller 60 includes the comprehensive ABS control unit 60a and the hydraulic ABS control unit 60b. The parking brake controller 62 includes a parking brake ABS control unit 62a.

The hydraulic controller 60, the service brake controller 61, and the regenerative brake controller 63 control the distribution between the regenerative brake and the hydraulic brake so as to maximize the amount regenerated by the regenerative brake 4 when the vehicle is normally braked. Further, the master cylinder pressure is controlled and the stroke amount on the brake pedal 2 side is controlled so as to prevent or reduce the change thereof at the time of the shift between the regenerative brake and the hydraulic brake when the regenerative brake is activated.

In the third embodiment, the braking force under the ABS control, which prevents or reduces the lock of the wheel when the wheel slips, is realized by the hydraulic control unit 3 and the electric parking brake 5. The comprehensive ABS control unit 60a calculates the braking torque required to be applied to each of the wheels so as to secure the force for braking the vehicle while preventing or reducing the lock of the wheel when the wheel slips (hereinafter referred to as the required braking torque). Then, the comprehensive ABS control unit 60a transmits the required braking torque having the smallest value of the required braking torques for the individual wheels (the minimum required braking torque) to the parking brake controller 62.

The parking brake ABS control unit 62a controls the braking torque for the rear wheel by the electric parking brake 5 based on the input minimum required braking torque. The hydraulic ABS control unit 60b controls the hydraulic control unit 3 based on the braking torque by which the minimum required torque is short of the required braking torque for the rear wheel. Further, the hydraulic ABS control unit 60b controls the braking torque for the front wheel based on the required braking torque for the front wheel.

[Function]

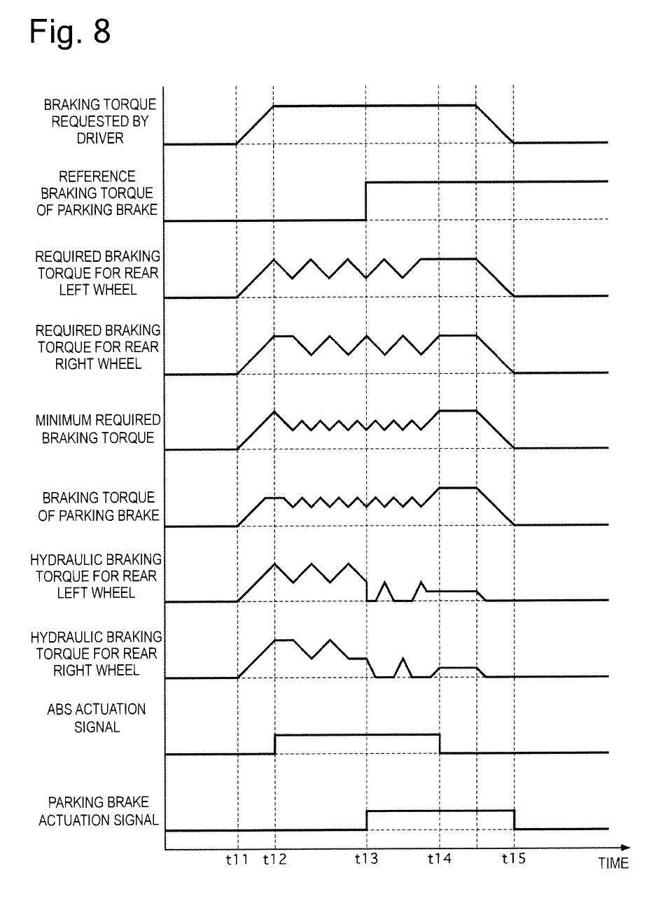

FIG. 8 is a timing diagram. The brake pedal 20 is operated by the driver, and the required braking torque is generated from time t11 to time t15. Then, the ABS activation signal is kept turned on and the ABS control continues the intervention from time t12 to time t14, during which the wheel slips at a high slip rate. Then, at time t13, the parking brake switch 51 is operated by the driver, so that a parking brake activation signal is turned on to activate the electric parking brake 5.

As illustrated in FIG. 8, the braking torque of the parking brake is output even when the parking brake switch 51 is operated with the ABS control continuing the intervention (after time t13). This output can enhance the power generation efficiency. Thus, the ABS control can be performed by utilizing another braking apparatus than the hydraulic brake. Further, the braking torque by which the braking torque of the parking brake is short of the required braking torque for the rear wheel is output as the hydraulic braking torque for each of the wheels. By this configuration, the required braking torque for each of the wheels can be performed.

[Effect]

(16) The electric parking brake 5 is an electric parking brake apparatus mounted on each of predetermined wheels of the wheels, and configured to electrically press brake pads against a brake disk mounted on the wheel according to an operation performed on the parking brake switch 51. The hydraulic controller 60 is configured to transmit, to the parking brake controller 62, the minimum required braking torque of the required braking torques for the rear wheels with the electric parking brake 5 mounted thereon that are predetermined of the wheels.

Therefore, the ABS control can be performed by utilizing anther braking apparatus than the hydraulic brake.

### Fourth Embodiment

The brake apparatus 1 according to a fourth embodiment will be described. The fourth embodiment is different from the first embodiment in terms of a part of the configurations of the controllers. Components similar to the first embodiment will be identified by the same reference numerals, and will not be described below.

[Configurations of Controllers]

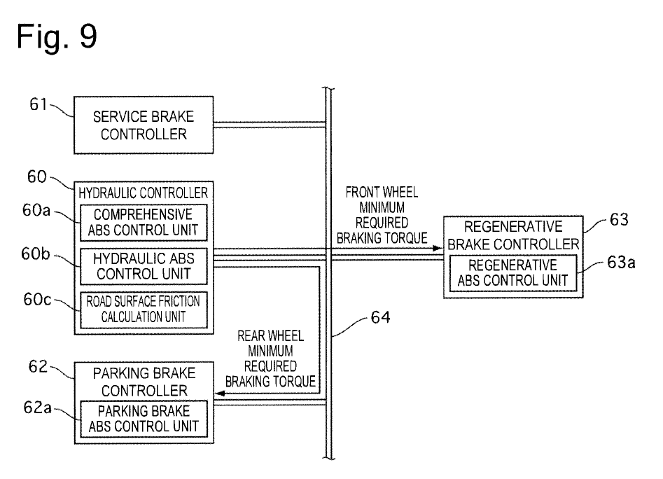

FIG. 9 is a block diagram illustrating the hydraulic controller 60, the service brake controller 61, the parking brake controller 62, and the regenerative brake controller 63. The hydraulic controller 60 includes the comprehensive ABS control unit 60a, the hydraulic ABS control unit 60b, and a road surface friction calculation unit 60c. The parking brake controller 62 includes the parking brake ABS control unit 62a. The regenerative brake controller 63 includes the regenerative ABS control unit 63a.

The hydraulic controller 60, the service brake controller 61, and the regenerative brake controller 63 control the distribution between the regenerative brake and the hydraulic brake so as to maximize the amount regenerated by the regenerative brake 4 when the vehicle is normally braked. Further, the hydraulic controller 60, the service brake controller 61, and the regenerative brake controller 63 control the master cylinder pressure and control the stroke amount on the brake pedal 2 side so as to prevent or reduce the change thereof at the time of the shift between the regenerative brake and the hydraulic brake when the regenerative brake is activated.

In the fourth embodiment, the braking torque under the ABS control, which prevents or reduces the lock of the wheel when the wheel slips, is realized by the hydraulic control unit 3, the regenerative brake 4, and the electric parking brake 5. The comprehensive ABS control unit 60a calculates the braking torque required to be applied to each of the wheels so as to secure the force for braking the vehicle while preventing or reducing the lock of the wheel when the wheel slips (hereinafter referred to as the required braking torque). This required braking torque is acquired according to a road surface frictional coefficient calculated by the road surface friction calculation unit 60c. Then, the braking torque having the smallest value between the required braking torques for the front wheels (a front wheel minimum required braking torque) is transmitted to the regenerative brake controller 63. Further, the braking torque having the smallest value between the required braking torques for the rear wheels (a rear wheel minimum required braking torque) is transmitted to the parking brake controller 62.

The regenerative ABS control unit 63a controls the braking torque for the front wheel by the regenerative brake 4 based on the input front wheel minimum required braking torque. The parking brake ABS control unit 62a controls the braking torque for the rear wheel by the electric parking brake 5 based on the input rear wheel minimum required braking torque. The hydraulic ABS control unit 60b controls the hydraulic control unit 3 based on the braking torque by which the front wheel minimum required torque is short of the required braking torque for the front wheel, and the braking torque by which the minimum required torque is short of the required braking torque for the rear wheel.

[Function]

The fourth embodiment is configured to generate the required braking torque for each of the wheels by the regenerative brake 4, the electric parking brake 5, and the hydraulic control unit 3 even when the ABC control intervenes. By this configuration, the regenerative brake 4 and the electric parking brake 5 can be operable even after the ABS control intervenes, and thus the ABS control can be performed by utilizing another braking apparatus than the hydraulic brake.

Further, in the fourth embodiment, the hydraulic controller 60 is configured to calculate the front wheel minimum required torque and the rear wheel minimum required torque, and transmit the front wheel minimum required braking torque to the regenerative brake controller 63 and the rear wheel minimum required braking torque to the parking brake controller 62. By this configuration, an addition of the calculation load on the parking brake controller 62 and the regenerative brake controller 63 can be prevented or reduced.

Further, in the fourth embodiment, the comprehensive ABS control unit 60a is configured to calculate the required braking torque for each of the wheels according to the road surface frictional coefficient calculated by the road surface friction calculation unit 60c. By this configuration, the required braking torque that matches the road surface frictional coefficient can be acquired, thereby efficiently preventing or reducing the slip of the wheel.

[Effect]

(17) The fourth embodiment includes the electric parking brake 5 (an electric parking brake apparatus) configured to electrically press the brake pads against the brake disk mounted on the rear wheel by the operation of the parking brake switch 51, and the regenerative brake 4 (a regenerative braking apparatus) configured to generate the electric braking torque, as another braking apparatus than the hydraulic control unit 3.

Therefore, the regenerative brake 4 and the electric parking brake can be kept operable even after the ABS control intervenes, and thus the ABS control can be performed by utilizing another braking apparatus than the hydraulic brake.

(18) The hydraulic controller 60 is configured to, when both the electric parking brake 5 and the regenerative brake 4 as the braking apparatus are activated and generate the braking forces at different wheels, transmit the smallest braking torques between the respective wheels where the braking torques are generated by the electric parking brake 5 and the regenerative brake 4 as the braking apparatus to the parking brake controller 62 and the regenerative brake controller 63, respectively.

Therefore, the addition of the calculation load on the parking brake controller 62 and the regenerative brake controller 63 can be prevented or reduced.

(19) The fourth embodiment includes the road surface friction calculation unit 60c configured to calculate the road surface frictional coefficient while the vehicle is running, and is configured in such a manner that the required braking torque includes a braking torque corresponding to the road surface friction that is set according to the calculated road surface frictional coefficient.

Therefore, the required braking torque that matches the road surface frictional coefficient can be acquired, thereby efficiently preventing or reducing the slip of the wheel.

(20) The hydraulic ABS control unit 60b is configured to increase and/or decrease by the hydraulic control unit 3 the braking torque which the braking torque corresponding to the road surface frictional coefficient subtracted from the required braking torque leaves.

Therefore, the ABS control can be made possible by causing the hydraulic control unit 3 to generate a difference between the required braking torque and the braking torque corresponding to the road surface friction.

### Fifth Embodiment

The brake apparatus 1 according to a fifth embodiment will be described. In the first to fourth embodiments, the vehicle is the front-wheel drive hybrid automobile or electric automobile. However, in the fifth embodiment, the vehicle is assumed to be a rear-wheel drive hybrid automobile or electric automobile. This means that the regenerative braking torque generated by the regenerative brake 3 is applied to the rear wheel. Components similar to the first embodiment will be identified by the same reference numerals, and will not be described below.

[Configurations of Controllers]

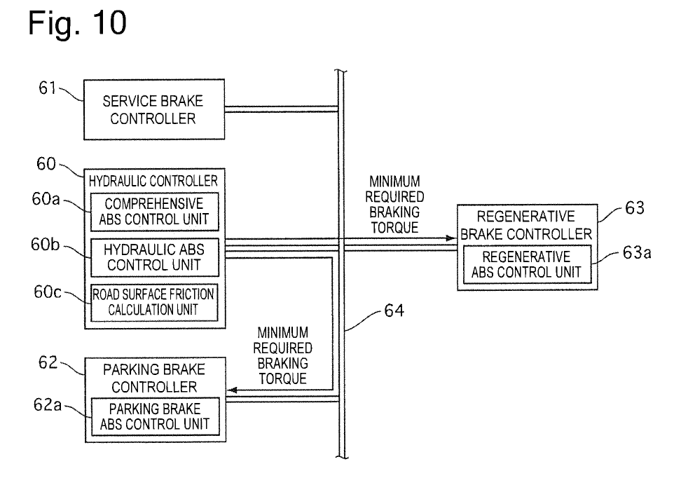

FIG. 10 is a block diagram illustrating the hydraulic controller 60, the service brake controller 61, the parking brake controller 62, and the regenerative brake controller 63. The hydraulic controller 60 includes the comprehensive ABS control unit 60a, the hydraulic ABS control unit 60b, and the road surface friction calculation unit 60c. The parking brake controller 62 includes the parking brake ABS control unit 62a. The regenerative brake controller 63 includes the regenerative ABS control unit 63a.

The hydraulic controller 60, the service brake controller 61, and the regenerative brake controller 63 control the distribution between the regenerative brake and the hydraulic brake so as to maximize the amount regenerated by the regenerative brake 4 when the vehicle is normally braked. Further, the hydraulic controller 60, the service brake controller 61, and the regenerative brake controller 63 control the master cylinder pressure and control the stroke amount on the brake pedal 2 side so as to prevent or reduce the change thereof at the time of the shift between the regenerative brake and the hydraulic brake when the regenerative brake is activated.

In the fifth embodiment, the parking torque under the ABS control, which prevents or reduces the lock of the wheel when the vehicle slips, is realized by the hydraulic control unit 3, the regenerative brake 4, and the electric parking brake 5. The comprehensive ABS control unit 60a calculates the braking torque required to be applied to each of the wheels so as to secure the force for braking the vehicle while preventing or reducing the lock of the wheel when the wheel slips (hereinafter referred to as the required braking torque). This required braking torque is calculated according to the road surface frictional coefficient calculated by the road surface friction calculation unit 60c. Then, the required braking torque having the smallest value of the required braking torque for the individual wheels (the minimum required braking torque) is transmitted to the parking brake controller 62 and the regenerative brake controller 63.

The regenerative ABS control unit 63a controls the braking torque for the rear wheel by the regenerative brake 4 based on the input minimum required braking torque when the regenerative brake activation signal is turned on. The parking brake ABS control unit 62a controls the braking torque for the rear wheel by the electric parking brake 5 based on the input minimum required braking torque when the parking brake switch 51 is operated to turn on the parking brake activation signal. The hydraulic ABS control unit 60b controls the hydraulic control unit 3 based on the braking torque by which the minimum required braking torque is short of the required braking torque for the rear wheel. Further, the hydraulic ABS control unit 60b controls the braking torque for the front wheel based on the required braking torque for the front wheel.

[Function]

In the fifth embodiment, the hydraulic controller 60 is configured to calculate the minimum required braking torque of the individual wheels, and transmit the minimum required torque to the parking brake controller 62 and the regenerative brake controller 63. By this configuration, the addition of the calculation load on the parking brake controller 62 and the regenerative brake controller 63 can be prevented or reduced.

[Effect]

(21) The hydraulic controller 60 is configured to, when both the electric parking brake 5 and the regenerative brake 4 as the braking apparatus are activated and generate the braking forces at the same wheels, transmit the smallest braking torque between the wheels
where the braking torques are generated by each of the electric parking brake 5 and
the regenerative brake 4 as the braking apparatus to the parking brake controller 62 and the regenerative brake controller 63.

Therefore, the addition of the calculation load on the parking brake controller 62 and the regenerative brake controller 63 can be prevented or reduced.

### OTHER EMBODIMENTS

Having described the present invention based on the first to fifth embodiments, the specific configuration of each invention is not limited to the first to fifth embodiments, and even a design change and the like are included in the present invention as long as this change and the like are made within the range that does not deviate from the gist of the present invention.

For example, in the first to fifth embodiments, the comprehensive ABS control unit 60a includes the hydraulic controller 60. However, any one of the service brake controller 61, the parking brake controller 62, and the regenerative brake controller 63 may include the comprehensive ABS control unit 60a.

Further, examples of technical ideas recognizable from the above-described embodiments will be listed below.

(X) A vehicle control apparatus, which is configured to be used together with a vehicle, includes a braking torque calculation unit configured to calculate a required braking torque for each of wheels of the vehicle when a wheel slips, a hydraulic control apparatus including a hydraulic anti-lock control unit configured to adjust a wheel cylinder hydraulic pressure by applying the calculated braking torque, and a braking apparatus provided separately from the hydraulic control apparatus and configured to generate a second braking torque. The hydraulic control apparatus and the braking apparatus are connected to each other so as to be able to communicate a result output by the braking torque calculation unit. The hydraulic control apparatus transmits the calculated braking torque to the braking apparatus. The braking apparatus includes a braking apparatus anti-lock control unit configured to generate the second braking torque based on the acquired calculated braking torque.
(A) In the vehicle control apparatus described in (X), the braking apparatus generates a smallest braking torque of or between the acquired braking torques for the wheels at each of the wheels as the second braking torque.
(B) In the vehicle control apparatus described in (A), the hydraulic control apparatus transmits the smallest braking torque of or between the calculated braking torques for the individual wheels to the braking apparatus, and the braking apparatus generates the acquired smallest braking torque at each of the wheels as the second braking torque.
(C) In the vehicle control apparatus described in (X), the braking apparatus is a regenerative braking apparatus configured to generate an electric braking torque.
(D) In the vehicle control apparatus described in (C), the hydraulic control apparatus transmits a minimum braking torque between braking torques for predetermined regenerative wheels of the wheels.
(E) In the vehicle control apparatus described in (C), when the wheel slips while the hydraulic control apparatus and the regenerative braking apparatus each generate a braking torque, the braking torque generated by the regenerative braking apparatus is reduced earlier than the braking torque generated by the hydraulic control apparatus is reduced.
(F) In the vehicle control apparatus described in (C), a driving torque is transmitted as the braking torque transmitted to the regenerative braking apparatus when the regenerative wheel largely slips.
(G) The vehicle control apparatus described in (X) further includes a braking booster configured to create a master cylinder hydraulic pressure according to an operation of a brake pedal by a driver, and a regenerative braking apparatus configured to generate an electric braking torque. The braking booster transmits a smallest braking torque of the braking torques for the individual wheels that are acquired from the hydraulic control apparatus to the regenerative braking apparatus as the second braking torque.
(H) In the vehicle control apparatus described in (X), the braking apparatus is an electric parking brake apparatus mounted on each of predetermined wheels of the wheels and configured to electrically press a brake pad against a disk brake mounted on each of the wheels according to an operation performed on a switch. The hydraulic control apparatus transmits a minimum braking torque between the braking torques for the wheels with the electric parking apparatus mounted thereon that are predetermined in the wheels.
(I) In the vehicle control apparatus described in (X), the braking apparatus includes an electric parking brake apparatus mounted on each of predetermined wheels of the wheels and configured to electrically press a brake pad against a disk brake mounted on each of the wheels according to an operation performed on a switch, and a regenerative braking apparatus configured to generate an electric braking torque.
(J) In the vehicle control apparatus described in (I), when both the electric parking apparatus and the regenerative braking apparatus as the braking apparatus are activated and generate braking forces at same wheels, the hydraulic control apparatus transmits a smallest braking force of the wheels where the braking forces are generated to the braking apparatus.
(K) In the vehicle control apparatus described in (I), when both the electric parking apparatus and the regenerative braking apparatus as the braking apparatus are activated and generate the braking forces at different wheels, the hydraulic control apparatus transmits smallest braking forces of the respective wheels where the braking forces are generated by the electric parking apparatus and the regenerative braking apparatus as the braking apparatus to the braking apparatus.
(L) The vehicle control apparatus described in (K) further includes a road surface friction calculation unit configured to calculate a road surface frictional coefficient while the vehicle is running. The braking torque includes a braking torque corresponding to road surface friction that is set according to the calculated road surface frictional coefficient.
(M) In the vehicle control apparatus described in (L), the hydraulic anti-lock control unit causes the hydraulic control apparatus to increase and/or decrease a braking torque acquired by subtracting the braking torque corresponding to the road surface friction from the braking torque.
(N) The vehicle control apparatus described in (X) further includes a vibration detection unit configured to detect a vibration of the wheel or a vehicle body including the wheel. The hydraulic control apparatus reduces the braking torque if the vibration is detected by the vibration detection unit.
(O) The vehicle control apparatus described in (X) further includes a first slip rate for triggering intervention of the hydraulic anti-lock control unit in anti-lock control, and a second slip rate for triggering intervention of the braking apparatus anti-lock control unit in the anti-lock control. The second slip rate is a lower slip rate than the first slip rate.
(P) In the vehicle control apparatus described in (X), in the braking torque transmitted to the braking apparatus the incremental gradient of the braking torque is less than the decremental gradient thereof.
(Q) A vehicle control apparatus includes a braking torque calculation unit configured to calculate a braking torque required to be applied to each of wheels of a vehicle when the wheel slips, a hydraulic anti-lock control unit configured to adjust a wheel cylinder hydraulic pressure by applying the calculated braking torque, and a braking torque transmission unit configured to transmit the braking torque calculated by the braking torque calculation unit to a regenerative braking apparatus configured to generate a regenerative braking torque at the wheel.
(R) A vehicle control apparatus includes a braking torque calculation unit configured to calculate a braking torque required to be applied to each of wheels of a vehicle when the wheel slips, a hydraulic anti-lock control unit configured to adjust a wheel cylinder hydraulic pressure by applying the calculated braking torque, and a braking torque transmission unit configured to transmit the braking torque calculated by the braking torque calculation unit to a braking apparatus configured to generate a second braking torque at the wheel.
(S) A vehicle control system, which is configured to be used together with a vehicle, includes a regenerative braking apparatus capable of generating a regenerative braking torque at a wheel, another braking apparatus than the regenerative braking apparatus and capable of generating a braking torque at the wheel, and a braking torque calculation unit configured to calculate a required braking torque for each of wheels of the vehicle when the wheel slips. The vehicle control system realizes the calculated braking torque by the regenerative braking apparatus and the other braking apparatus.
(t) The vehicle control system described in (H) causes the regenerative braking apparatus to generate a selected low braking torque, which is the smaller value between a maximum regenerative braking torque that the regenerative braking apparatus can generate, and a minimum value of the calculated braking torques. A difference between the unselected braking torque and the selected braking torque is generated by the other braking apparatus.

In one embodiment, the vehicle control apparatus or system can enhance the power generation efficiency because generating the regenerative braking torque by the regenerative braking apparatus even when the ABS control is in operation.

In one embodiment, the vehicle control apparatus or system can perform the ABS control while utilizing another braking apparatus than the hydraulic braking apparatus.

In one embodiment, the power generation efficiency can be enhanced because generating the regenerative braking torque by the regenerative braking apparatus even when the ABS control is in operation.

In one embodiment, the power generation efficiency can be enhanced because generating the regenerative braking torque by the regenerative braking apparatus even when the ABS control is in operation.

Having described merely several embodiments of the present invention, it is apparent to those skilled in the art that the embodiments described as examples can be changed or improved in various manners without substantially departing from the novel teaching and advantages of the present invention. Therefore, such embodiments changed or improved in various manners are intended to be also contained in the technical scope of the present invention.

This application claims priority under the Paris Convention to Japanese Patent Application No. 2013-234033 filed on Nov. 12, 2013. The entire disclosure of Japanese Patent Application No. 2013-234033 filed on Nov. 12, 2013 including the specification, the claims, the drawings, and the summary is incorporated herein by reference in its entirety.

The entire disclosure of Japanese Patent Application Public Disclosure No. 2012-131306 (PTL 1) including the specification, the claims, the drawings, and the summary is incorporated herein by reference in its entirety.

### REFERENCE SIGNS LIST

3 hydraulic control unit (braking apparatus)
4 regenerative brake (regenerative braking apparatus)
5 electric parking brake (electric parking brake apparatus)
22 electric booster (braking booster)
40 regenerative brake controller (braking apparatus, regenerative braking apparatus)
60 hydraulic controller (hydraulic control apparatus)
60a comprehensive ABS controller (braking torque calculation unit)
60b hydraulic ABS control unit (hydraulic anti-lock control unit)
60c road surface friction calculation unit
61 service brake controller (braking booster)
63 regenerative brake controller (braking apparatus, regenerative braking apparatus)
64 CAN (braking torque transmission unit)
69 vibration sensor (vibration detection unit)

1. A vehicle control apparatus configured to be used together with a vehicle, the vehicle control apparatus comprising:
a braking torque calculation unit configured to calculate a required braking torque for each of wheels of the vehicle when a wheel slips;
a hydraulic control apparatus including a hydraulic anti-lock control unit configured to adjust a wheel cylinder hydraulic pressure by applying the calculated braking torque; and
a braking apparatus provided separately from the hydraulic control apparatus and configured to generate a second braking torque,
wherein the hydraulic control apparatus and the braking apparatus are connected to each other so as to be able to communicate a result output by the braking torque calculation unit,
wherein the hydraulic control apparatus transmits the calculated braking torque to the braking apparatus, and
wherein the braking apparatus includes a braking apparatus anti-lock control unit configured to generate the second braking torque based on the acquired calculated braking torque.

2. The vehicle control apparatus according to claim 1, wherein the braking apparatus generates a smallest braking torque of the acquired braking torques for the wheels at each of the wheels as the second braking torque.

3. The vehicle control apparatus according to claim 2, wherein the hydraulic control apparatus transmits the smallest braking torque of the calculated braking torques for the individual wheels to the braking apparatus, and the braking apparatus generates the acquired smallest braking torque at each of the wheels as the second braking torque.

4. The vehicle control apparatus according to claim 1, wherein the braking apparatus is a regenerative braking apparatus configured to generate an electric braking torque.

5. The vehicle control apparatus according to claim 4, wherein the hydraulic control apparatus transmits a minimum braking torque between braking torques for predetermined regenerative wheels of the wheels.

6. The vehicle control apparatus according to claim 4, wherein, when the wheel slips while the hydraulic control apparatus and the regenerative braking apparatus each generate a braking torque, the braking torque generated by the regenerative braking apparatus is reduced earlier than the braking torque generated by the hydraulic control apparatus is reduced.

7. The vehicle control apparatus according to claim 4, wherein a driving torque is transmitted as the braking torque transmitted to the regenerative braking apparatus when the regenerative wheel largely slips.

8. The vehicle control apparatus according to claim 1, further comprising:
a braking booster configured to create a master cylinder hydraulic pressure according to the operation of a brake pedal by a driver; and
a regenerative braking apparatus configured to generate an electric braking torque,
wherein the braking booster transmits a smallest braking torque of the braking torques for the individual wheels that are acquired from the hydraulic control apparatus to the regenerative braking apparatus as the second braking torque.

9. The vehicle control apparatus according to claim 1, wherein the braking apparatus is an electric parking brake apparatus mounted on each of predetermined wheels of the wheels and configured to electrically press a brake pad against a disk brake mounted on each of the wheels according to the operation of a switch, and
wherein the hydraulic control apparatus transmits a minimum braking torque between the braking torques for the wheels with the electric parking apparatus mounted thereon that are predetermined in the wheels.

10. The vehicle control apparatus according to claim 1, wherein the braking apparatus includes
an electric parking brake apparatus mounted on each of predetermined wheels of the wheels and configured to electrically press a brake pad against a disk brake mounted on each of the wheels according to the operation of a switch, and
a regenerative braking apparatus configured to generate an electric braking torque.

11. The vehicle control apparatus according to claim 10, wherein, when both the electric parking apparatus and the regenerative braking apparatus as the braking apparatus are activated and generate braking forces at same wheels, the hydraulic control apparatus transmits a smallest braking force of the wheels where the braking forces are generated to the braking apparatus.

12. The vehicle control apparatus according to claim 10, wherein, when both the electric parking apparatus and the regenerative braking apparatus as the braking apparatus are activated and generate the braking forces at different wheels, the hydraulic control apparatus transmits smallest braking forces of the respective wheels where the braking forces are generated by the electric parking apparatus and the regenerative braking apparatus as the braking apparatus to the braking apparatus.

13. The vehicle control apparatus according to claim 1, further comprising a road surface friction calculation unit configured to calculate a road surface frictional coefficient while the vehicle is running,
wherein the braking torque includes a braking torque corresponding to road surface friction that is set according to the calculated road surface frictional coefficient.

14. The vehicle control apparatus according to claim 13, wherein the hydraulic anti-lock control unit causes the hydraulic control apparatus to increase and/or decrease a braking torque acquired by subtracting the braking torque corresponding to the road surface friction from the braking torque.

15. The vehicle control apparatus according to claim 1, further a v b at on detection unit configured to detect a vibration of the wheel or a vehicle body including the wheel,
wherein hydraulic control apparatus reduces the braking torque if the vibration is detected by the vibration detection unit.

16. The vehicle control apparatus according to claim further comprising:
first slip rate for triggering intervention of t hydraulic anti-lock control unit in anti lock control;
a second slip rate for triggering intervention of the braking apparatus anti-lock control unit in the anti-lock control, the second slip rate being a lower slip rate than first slip rate.

17. The vehicle control apparatus according to claim 1, wherein in the braking torque transmitted to the braking apparatus, the incremental, gradient of the braking torque is less than the decremental gradient thereof.

18. A vehicle control apparatus comprising:
a braking torque calculation unit configured to calculate a braking torque required to be applied to each of wheels of vehicle when the heel slips;
a hydraulic anti lock control unit configured to adjust wheel cylinder hydraulic pressure by applying the calculated braking torque; and
a braking torque transmission unit configured to transmit the braking torque calculated by the braking torque configured to generate a regenerative braking torque at the wheel.

19. A vehicle control apparatus comprising:
a braking torque calculation unit configured to calculate a braking torque required to be applied to each of wheels of a vehicle when the wheel slips;
a hydraulic anti-lock control unit configured to adjust a wheel cylinder hydraulic pressure by applying the calculated braking torque; and
a braking torque transmission unit configured to transmit the braking torque calculated by the braking torque calculation unit to a braking apparatus configured to generate a second braking torque at the wheel.

20. A vehicle control system for a vehicle, the vehicle control system comprising:
a regenerative braking apparatus capable of generating a regenerative braking torque at a wheel;
another braking apparatus than the regenerative braking apparatus, the other braking apparatus capable of generating a braking torque at the wheel; and
a braking torque calculation unit configured to calculate a required braking torque for each of wheels of the vehicle when the wheel slips,
wherein the calculated braking torque is realized by the regenerative braking apparatus and the other braking apparatus.

21. The vehicle control system according to claim 20, wherein a selected low braking torque, which is the smaller value between a maximum regenerative braking torque that the regenerative braking apparatus can generate and, the calculated braking torques is generated the regenerative braking apparatus,
wherein a difference between the unselected braking torque and the selected braking torque is generated by the other braking apparatus.
